(19) United States
(12) Patent Application Publication
(10) Pub. No.: US 2015/0129479 A1
(43) Pub. Date: May 14, 2015

(54) ROTATIONAL FILTER ASSEMBLY WITH ORIENTATION STRUCTURE

(71) Applicants: Samir D. Dhawale, Carol Stream, IL (US); Gary Svidron, Lemont, IL (US)

(72) Inventors: Samir D. Dhawale, Carol Stream, IL (US); Gary Svidron, Lemont, IL (US)

(73) Assignee: International Engine Intellectual Property Company LLC, Lisle, IL (US)

(21) Appl. No.: 14/396,151

(22) PCT Filed: Apr. 26, 2012
(86) PCT No.: PCT/US12/35176

§ 371 Date: Oct. 22, 2014

(51) Int. Cl. B01D 35/00; B01D 35/30

(52) U.S. Cl. CPC B01D 35/005; B01D 35/306
USPC 210/232; 29/468

(57) ABSTRACT

A filter element for attachment to a filter cap includes a generally cylindrical filter media defining an axial centerline. The filter element also includes an upper plate attached to the filter media and rotationally attacked to the filter cap such that the upper plate and the filter media are rotational about the centerline with respect to the filter cap. The filter element further includes a bottom plate attached to the filter media opposite from the rotational attachment of the upper plate to the filter cap, and an orientation structure extending from the bottom plate radially from the centerline.

### BACKGROUND

Embodiments described herein relate generally to filter assemblies for vehicle components, and more particularly, to filter assemblies having orientation features for installation in housings of vehicle components.

Filter elements are used in many different aspects of vehicle components and systems for filtering various fluids and particulates, for example for filtering fuel, oil, coolant, air, among others. Proper functioning of the vehicle components and systems may rely on the filter element being installed in a particular orientation with respect to a housing to cooperate with the other vehicle components. Since the filter element may be positioned within the housing of a vehicle component, it may often times be difficult for the user to orient the filter element with respect to the vehicle component.

### SUMMARY

A rotational filter assembly configured for cooperation with a vehicle component includes a generally cylindrical filter defining an axial centerline. The filter has a filter cap and a filter element attached to the filter cap, where the filter element is rotational with respect to the filter cap. The filter element includes a filter media that is generally centered on the centerline and an orientation structure extending radially with respect to the centerline. The rotational filter assembly also includes a housing having a generally cylindrical inner surface generally centered on the centerline, where the inner surface defines a receiving structure configured for receiving and engaging the orientation structure of the filter element. The filter element is independently rotational of the filter cap with respect to the housing. The receiving structure of the housing guides the orientation structure such that the filter element has a predetermined rotational position with respect to the housing, irrespective of the rotational position of the filter cap to the housing.

A filter element for attachment to a filter cap includes a generally cylindrical filter media defining an axial centerline. The filter element also includes an upper plate attached to the filter media and configured to be rotationally attachable to the filter cap such that the upper plate and the filter media are rotational about the centerline with respect to the filter cap. The filter element further includes a bottom plate attached to the filter media opposite from the upper plate, and an orientation structure extending from the bottom plate radially from the centerline.

A method of orienting a filter element with respect to a housing, where the filter element is attached to a filter cap to form a filter, includes the steps of engaging the filter cap with the housing, and guiding an orientation structure of the filter element in a receiving structure of the housing. The method further includes the step of rotating the filter element independently of the filter cap with respect to the housing. The rotation of the filter element is determined by the engagement of the orientation structure with the receiving structure and the geometry of the receiving structure. The filter element is rotated by the receiving structure to a predetermined rotational position with respect to the housing.

### BRIEF DESCRIPTION OF THE DRAWINGS

FIG. 1 is a partial section view of a filter element of a filter assembly having an orientation structure received in a receiving structure of a housing, where the housing houses a regulator valve assembly that is in a first position.

FIG. 2 is a partial section view of the filter element having the orientation structure in the receiving structure of the housing, where the regulator valve is in a second position.

FIG. 3 a partial section view of a filter element, where the regulator valve is in a third position.

FIG. 4 is a partial section view of a second embodiment of filter element of a filter assembly having an orientation structure in a receiving structure of a housing, where the housing defines a passageway.

FIG. 5 is a perspective view of the receiving structure located on the housing.

FIG. 6 is an unfolded view of the housing showing the receiving structure located on the inner surface of the housing.

FIG. 7 is a perspective view of a second embodiment of receiving structure located on the housing.

FIG. 8 is an unfolded view of the housing showing the second embodiment of the receiving structure located on the inner surface of the housing.

FIG. 9 is a section view of a filter having the second embodiment of filter element and a filter cap.

### DETAILED DESCRIPTION

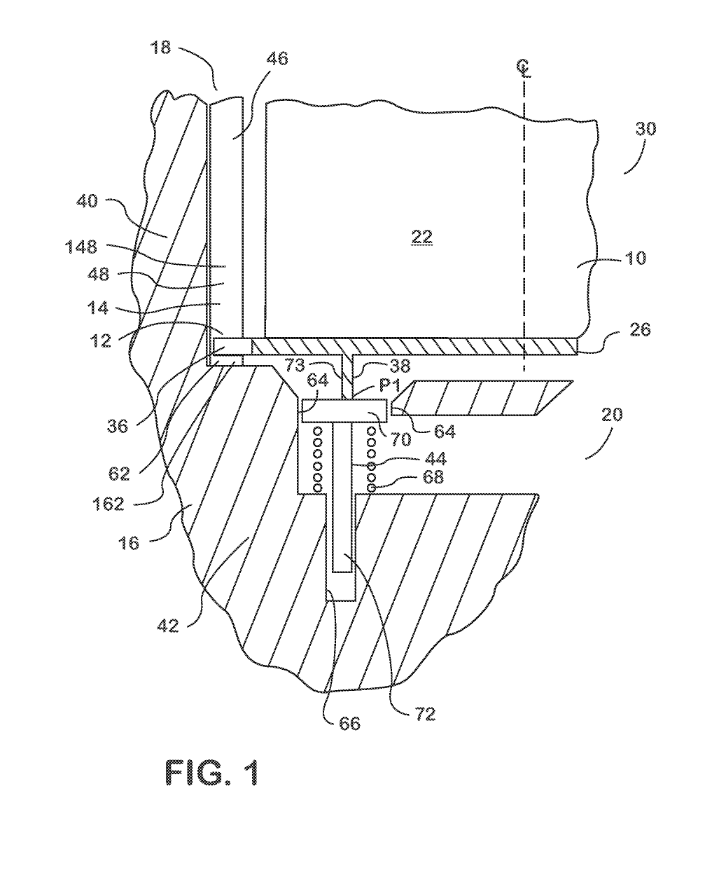

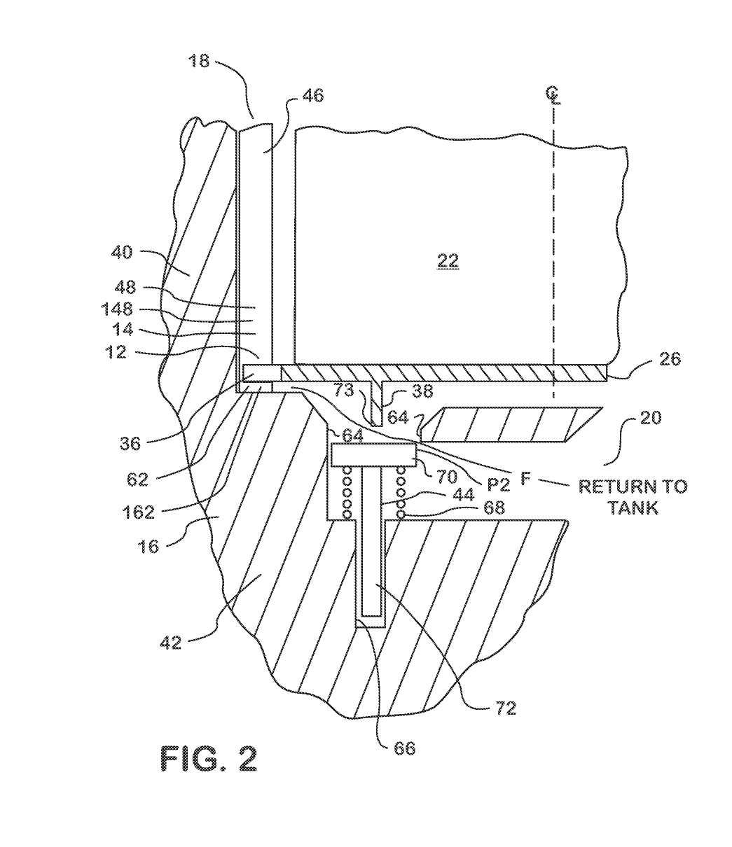

Referring to FIGS. 1-2, a filter element is indicated generally at 10 and includes an orientation structure 12 that is received in a receiving structure 14 of a housing 16 to form a rotational filter assembly 18. While the filter element 10 and the housing 16 will be explained with reference to use in a fuel system 20 of a vehicle, it should be appreciated that the filter element 10 can be used in any application for fluid or particulate filtration where the filter element is received in a housing 16. For example, the filter element 10 can filter oil, coolant, air, exhaust gas, among other fluids and particulate in an oil filter housing, a coolant passageway housing, an air or exhaust gas passageway housing, among other housings.

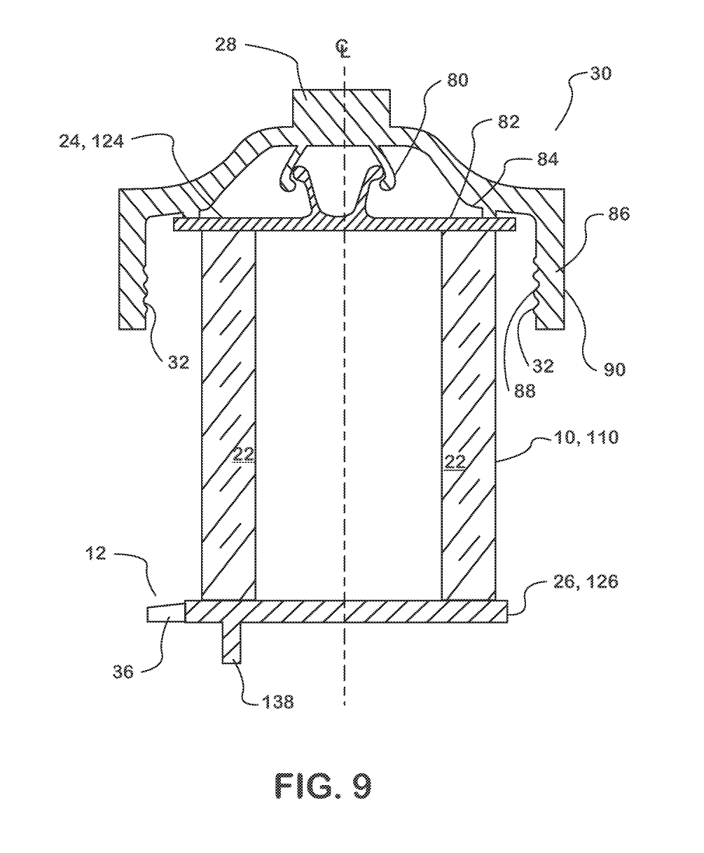

The filter element 10 includes a generally cylindrical filter media 22 that is disposed between an upper plate 24 (see FIG. 9) and a bottom plate 26 that are disposed generally transverse to the axial centerline CL of the filter element. In FIGS. 1-2, a portion of the filter element 10 is shown, indicated by the centerline CL, and the bottom plate 26 of the filter element is shown sectioned while the generally cylindrical filter media 22 is shown non-sectioned.

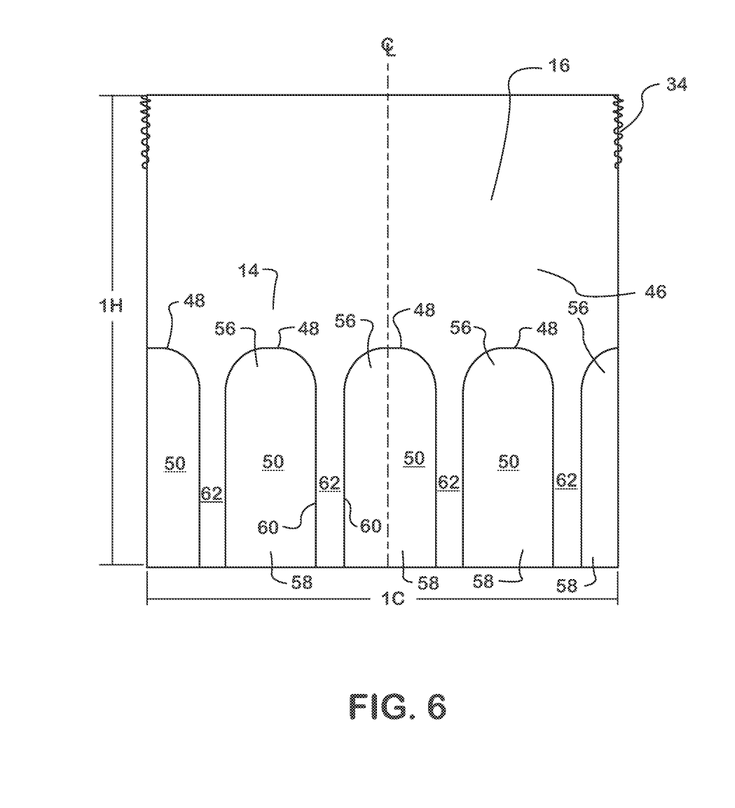

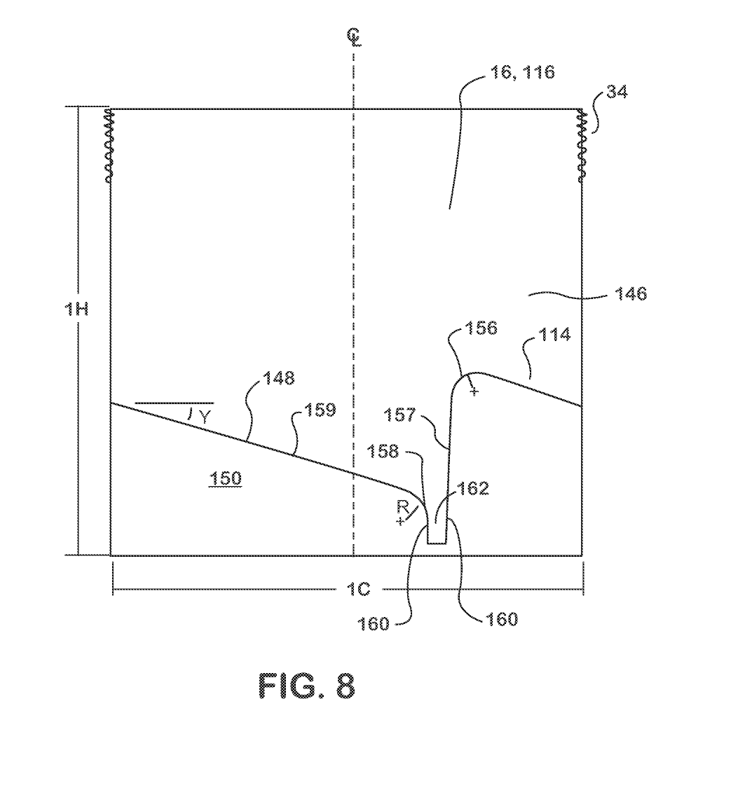

As will be described in more detail with respect to FIG. 9 below, the filter element 10 is attached to and rotational with respect to a filter cap 28 to form a filter 30, the filter cap 28 having threads 32 to engage threads 34 on the housing 16 (not shown in FIGS. 1-2, but see FIG. 6 and FIG. 8). When the filter cap 28 and the filter element 10 are installed into the housing 16, the threads 32 of the filter cap 28 engage the threads 34 on the housing 16, and the filter cap rotates with respect to the housing as dictated by the configuration of the threads 32, 34 as the filter 30 axially displaces with respect to the housing. The filter element 10 is rotatable with respect to the filter cap 28 about centerline CL, so the rotation of the filter element 10 is not dictated by the threads 32 on the filter cap or the threads 34 on the housing 16.

Extending from the bottom plate 26 in the radial direction with respect to the filter element 10 is the orientation structure 12 for orienting the filter element with respect to the housing 16. The orientation structure 12 may be any mechanical feature that is configured to engage or be guided by the receiving structure 14, for example a radial guiding tab 36, however the orientation structure may have other sizes, shapes or configurations such as a roller. The guiding tab 36 may be integrally formed with the bottom plate 26 or may be attached to the bottom plate, and may be generally coplanar with the bottom plate 26. The guiding tab 36 may have a generally rectangular parallelepiped shape, or have any other shape that can be received in the receiving structure 14 of the housing. The guiding tab 36 is radially aligned with a protrusion 38 (with respect to the centerline CL) that extends from the bottom plate 26 in the axial direction of the filter element 10.

In the fuel system 20, the housing 16 has a first portion 40 configured for receiving the filter 30, and a second portion 42 configured for housing a regulator valve 44. The first portion 40 of the housing 16 has a generally cylindrical inner surface 46 that defines the receiving structure 14 for receiving the orientation structure 12 of the filter element 10.

Referring to FIGS. 1-2 and 5-8, the receiving structure 14 may be at least one internal element guide path 48 that is defined by at least one inwardly projecting body 50, however the receiving structure may have other configurations such as projecting ribs defining a track, among others. The guidance of the guiding tab 36 by the internal element guide path 48 angularly positions the protrusion 38 on the filter element 10 with respect to housing 16 for cooperation with other components of the fuel system 20, as will be described in more detail below.

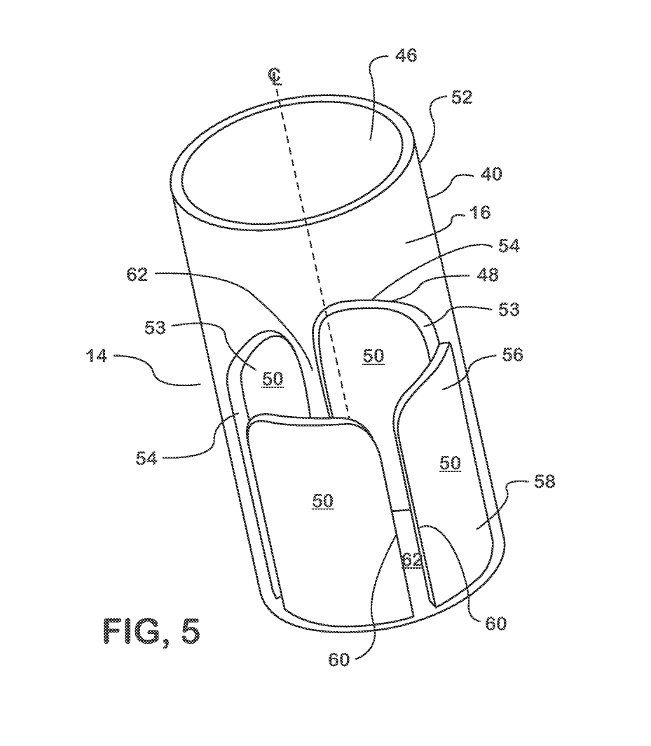

A first embodiment of receiving structure 14 is shown in FIGS. 5-6. The inner surface 46 of the housing 16 is generally cylindrical about centerline CL. While the outer surface 52 of the housing 16 is shown as cylindrical in FIG. 5, it should be understood that FIG. 5 is for the purposes of viewing the internal element guide path 48 and the outer surface of the housing may have other shapes. Extending radially inwardly towards the centerline CL and defining the inner surface 46 of the housing is the at least one inwardly projecting body 50. The inwardly projecting bodies 50 may have generally concentric surfaces 53 that are generally concentric about the centerline CL with the inner surface 46, and generally radial surfaces 54 that are generally radial with respect to the centerline CL. The at least one generally radial surface 54 defines the at least one internal element guide path 48. As the filter element 10 is installed within the housing 16, the at least one guiding tab 36 contacts the inner surface 46 at the radial surfaces 54 that define the internal element guide path 48.

In the unfolded view of the housing 16 of FIG. 6, the housing has an inside height IH and an inner circumference IC. At one end of the housing inside height IH are the threads 34, and at the opposite end of the housing 16 are the inwardly projecting bodies 50. Each inwardly projecting body 50 has a top portion 56, which due to turning of the filter cap 28 and displacement of the filter 30 into the housing 16 during installation, the top portion is generally radiused. A bottom portion 58 of the inwardly projecting body 50 has generally linear opposing walls 60 that form internal element guide passages 62, which are portions of the internal guide path 48 that are located between adjacent inwardly projecting bodies 50. The opposing walls 60 receive the guiding tab 36 therebetween. Upon filter cap 28 tightening, the top portion 56 defines the internal element guide path 48 that guides the guiding tab 36 into the guide passages 62.

The rotation of the filter element 10 is independent of the filter cap 28 and is dictated by the geometry of the receiving structure 14 that defines the internal element guide path 48 and the internal element guide passage 62. The guiding tab 36 is sized and shaped to be received within the internal element guide passages 62.

The number of guiding tabs 36 and the number of radially aligned protrusions 38 may be equal to the number of internal element guide passages 62. For example, the filter element 10 may have four guiding tabs 36 and four aligned protrusions 38 that are received by the four internal element guide passages 62 shown in FIG. 6, however other numbers are possible. The number of guiding tabs 36 may be equal to the number of protrusions 38 such that when the filter element 10 is installed in the housing 16, at least one protrusion 38 will be configured to position the regulator valve 44 at a predetermined vertical first position P1 of the protrusion (see FIG. 1). Further, while the guiding tabs 36 and the protrusions 38 may be radially aligned, it is possible that they can be radially offset as long as when the guiding tabs 36 are received in the internal element guide passages 62, the protrusion 38 is generally radially and axially aligned over the top of the regulator valve 44.

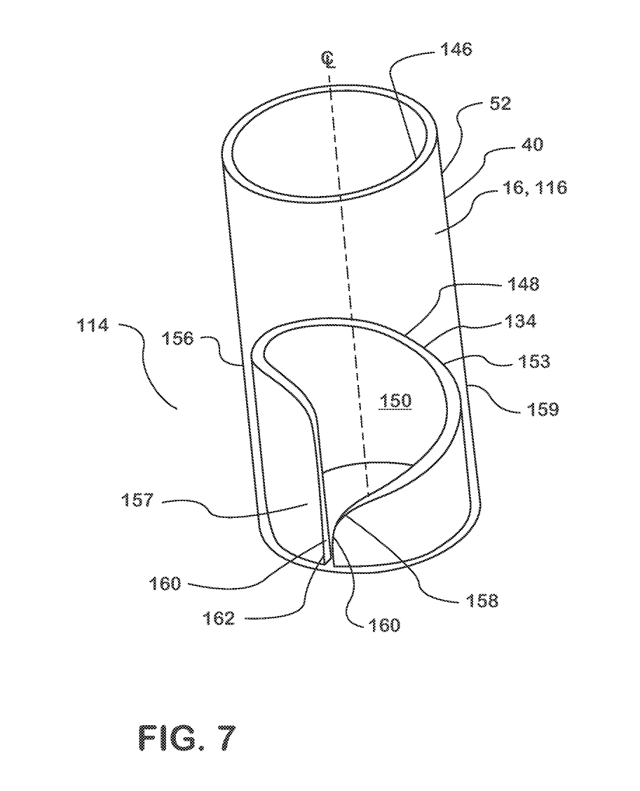

Referring now to FIGS. 7-8 a second embodiment of receiving structure 114 is generally similar to the receiving structure 14 and similar components are referenced with identical numbers and differing components are referenced with numbers in the 100-series. The receiving structure 114 includes a generally cylindrical inner surface 146 of the housing 16. The outer surface 52 of the housing may be cylindrical or may have other shapes. Extending radially inwardly towards the centerline CL and defining the inner surface 146 of the housing is at least one inwardly projecting body 150. The inwardly projecting body 150 may have a generally concentric surface 153 and a generally radial surface 154 that defines the at least one internal element guide path 148. As the filter element 10 is installed within the housing 16, the guiding tab 36 contacts the inner surface 146 at the radial surface 154 that defines the internal element guide path 148.

In the unfolded view of the housing 16 in FIG. 8, the housing has an inside height IH and an inner circumference IC. At one end of the housing inside height IH are the threads 34, and at the opposite end of the housing 16 is the inwardly projecting body 150. The inwardly projecting body 150 has a top portion 156, which due to turning of the filter cap 28 and displacement of the filter 30 into the housing 16, the top portion defines a generally radiused internal element guide path 148. A bottom portion 158 of the inwardly projecting body 150 also defines a generally radiused internal guide path 148. A middle portion 159 of the inwardly projecting body defines the guide path 148 between the top portion 156 and the bottom portion 158. Between the bottom portion 158 and the top portion 156 is an intermediate portion 157 that is generally linear and vertical. An internal element guide passage 162 is defined between the radiused bottom portion 158 and the intermediate portion 157 and has opposing walls 160 for receiving the guiding tab 36 therebetween. Upon filter cap 28 tightening, the top portion 156, the middle portion 159 and the bottom portion 158 define the internal element guide path 148 that guides the guiding tab 36 into the guide passage 162.

The rotation of the filter element 10 is independent of the filter cap 28 and is dictated by the geometry of the receiving structure 114 that defines the internal element guide path 148 and the internal element guide passage 162. The geometry of the inwardly projecting body 150 may define a generally helical internal element guide path 148 and internal element guide passage 162, with the helix angle γ being greater than the helix angle of the threads 32 of the filter cap 28. The guiding tab 36 is sized and shaped to be received in the opposing walls 160 of the internal element guide passage 162.

To account for the displacement of the filter 30 with respect to the housing 16 upon installation, the distance Z (see FIG. 8) between the center of the bottom radius R and the top of housing 16 may be less than the distance Y (see FIG. 9) between the bottom of the radial guiding tab 36 and the bottom of threads 32. Further, the distance X (see FIG. 8) between the bottom of the internal element guide passage 162 may be less than the vertical, axial distance displaced by the filter cap 28. It should be appreciated that these distances are variable.

The filter element 10 may have one guiding tab 36 and one aligned protrusion 38 that is received by the single element guide passage 162 shown in FIG. 8. The number of guiding tabs 36 may be equal to the number of protrusions 38 such that when the filter element 10 is installed in the housing 16, at least one protrusion 38 will be configured to position the regulator valve 44 at a predetermined vertical first position P1 (see FIG. 1). Further, while the guiding tab 36 and the protrusion 38 may be radially aligned, it is possible that they can be radially offset as long as when the guiding tab 36 is received in the internal element guide passage 162 the protrusion 38 is generally centered over (rotationally and axially aligned with) the regulator valve 44.

Referring back to FIG. 1, the protrusion 38 is configured to position the regulator valve 44 against a housing seal surface 64 at the predetermined axial and radial first position P1 of the protrusion. The regulator valve 44 is seated in a guide 66 defined by the second portion 42 of the housing 16. A spring 68 may be disposed between a disk 70 of the regulator valve 44 and the housing 16, and may be disposed about the stem 72 of the regulator valve. In the first, predetermined position P1 of the protrusion 38, the regulator valve 44 abuts the protrusion and may seal or allow some fluid flow F through the housing seal surface 64. The length of the filter 30 and the corresponding length of the housing 16 determines the end stop location of the distal end 73 of the protrusion 38 such that the protrusion will contact the disk 70 of the regulator valve 44 at the predetermined position P1 upon installation of the filter 30. The guidance of the guiding tab 36 within the internal element guide path 48, 148 and internal element passage 62, 162 protects the regulator valve 44 from a bending force that may otherwise be imparted on it during filter cap 28 tightening.

As seen in FIG. 2, the regulator valve 44 is depressed against the spring 68 by system pressure to allow for extra fluid flow F past the regulator valve to regulate the fuel system 20 pressure. The regulator valve 44 is retracted into the guide 66 in a second position P2 and fluid flow F may return to the tank.

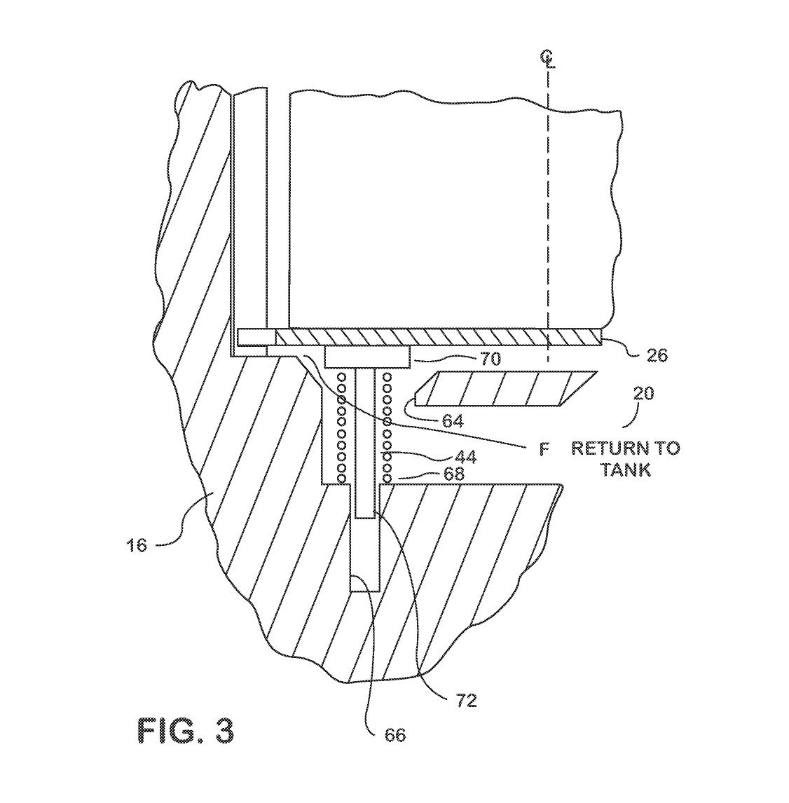

Referring to FIG. 3, without a protrusion 38 on the filter element or without a filter element that is aligned with the regulator valve 44, the regulator valve 44 may extend to a bottom surface of the bottom plate 26, allowing fluid flow F past the regulator valve to return to the tank. Without the protrusion 38 to position the regulator valve 44 at the predetermined height, the fuel system 20 does not build pressure.

With the filter element 10 that is independently rotational of the filter cap 28 with respect to the housing 16, the receiving structure 14 of the housing guides the orientation structure 12 such that the filter element has a predetermined rotational position with respect to the housing, irrespective of the rotational position of the filter cap to the housing. In this way, the protrusion 38 on the filter element 10 may be rotationally aligned with the regulator valve 44 or other vehicle component.

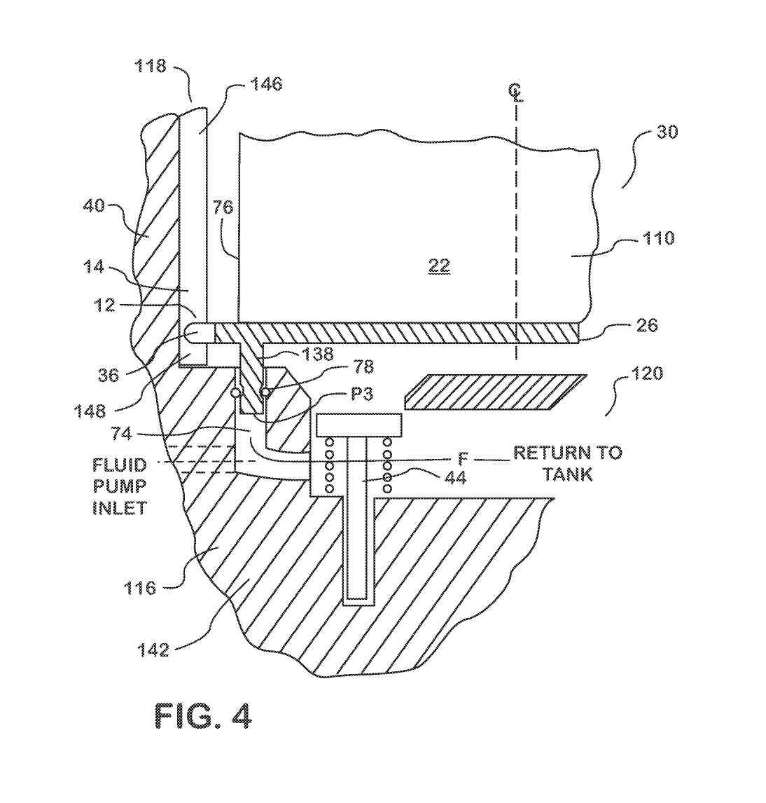

Referring now to FIG. 4, a second embodiment of filter element 110 and a second embodiment of housing 116 are generally similar to the filter element 10 and the housing 16, where similar components are referenced with identical numbers and differing components are referenced with numbers in the 100-series. Together, the filter element 110 and the housing 116 form a second embodiment of rotational filter assembly 118 for a fuel system 120 having an orientation structure 12 and a receiving structure 14.

The filter element 110 includes the generally cylindrical filter media 22 that is disposed between the upper plate 24 (see FIG. 9) and the bottom plate 26 that are generally transverse to the centerline CL of the filter element. In FIG. 4, a portion of the filter element 110 is shown, indicated by the centerline CL, and the bottom plate 26 of the filter element is shown sectioned while the generally cylindrical filter media 22 is shown non-sectioned.

As will be described in more detail in FIG. 9 below, the filter element 110 is attached to and rotational with respect to the filter cap 28 (see FIG. 9) to form the filter 30, the filter cap 28 having threads 32 to engage threads 34 on the housing 16 (see FIG. 6 and FIG. 8). When the filter cap 28 and the filter element 110 are installed into the housing 116, the threads 32 of the filter cap 28 engage the threads 34 on the housing 116, and the filter cap rotates with respect to the housing as dictated by the configuration of the threads 32, 34 as the filter 30 axially displaces with respect to the housing. The filter element 110 is rotatable with respect to the filter cap 28 about centerline CL, so the rotation of the filter element 110 is not dictated by the threads 32 on the filter cap or the threads 34 on the housing 16. In other words, the filter element 110 is independently rotational of the filter cap 28 with respect to the housing 116, and the receiving structure 14 of the housing guides the orientation structure 12 such that the filter element has a predetermined rotational position with respect to the housing, irrespective of the rotational position of the filter cap to the housing. In this way, the protrusion 138 on the filter element 110 may be rotationally aligned with a return-to-tank passageway 74 or other vehicle component.

Extending from the bottom plate 26 in the radial direction of the filter element 110 is the orientation structure 12 for orienting the filter element with respect to the housing 116. The orientation structure 12 may be a radial guiding tab 36, however the orientation structure may have other sizes, shapes or configurations. The guiding tab 36 may be integrally formed with the bottom plate 26 or may be attached to the bottom plate, and may be generally coplanar with the bottom plate 26. The guiding tab 36 may have a generally rectangular parallelepiped shape, or have any other shape that can be received in the receiving structure 14 of the housing. The guiding tab 36 is radially aligned with a protrusion 138 that extends from the bottom plate 26 in the axial direction of the filter element 10.

Still referring to FIG. 4, the housing 116 has a first portion 40 configured for receiving the filter 30, and a second portion 142 configured for housing a regulator valve 44 and defining a return-to-tank passageway 74. The first portion 40 of the housing 116 has the generally cylindrical inner surface 146 that defines the receiving structure 14 for receiving the orientation structure 12 of the filter element 110.

The return-to-tank passageway 74 is defined by the second portion 142 of the housing 116 to be generally parallel to the centerline CL of the filter element 110, and may be disposed a radial distance from the centerline CL and generally parallel with a longitudinal edge of the filter element 76, however other locations are possible. The return-to-tank passageway 74 may be in fluid communication with the fuel tank and/or the fluid inlet pump.

The protrusion 138 extends axially from the bottom plate 26 and is configured to be received in the return-to-tank passageway 74. The protrusion 138 may be generally cylindrical or have other shapes. An O-ring 78 or other seal is disposed on the protrusion 138 for sealing the return-to-tank-passageway 74. In the sealed configuration, system pressure may be built up due to the flow-over regulator valve 44.

The first portion 40 of the housing 116 may include the internal element guide path 148 of FIGS. 7 and 8, however other receiving structures are possible. The filter element 110 may have one guiding tab 36 and one aligned protrusion 138 that is received by the single element guide passage 162 shown in FIG. 8, such that when the filter element 110 is installed in the housing 116, the protrusion 138 will be aligned and received within the return-to-tank passageway 74 at position P3. Further, while the guiding tab 36 and the protrusion 138 may be radially aligned, it is possible that they can be radially offset as long as when the guiding tab 36 is received in the internal element guide passage 162 the protrusion 138 is positioned within the return-to-tank passageway 74 (rotationally and axially aligned with the return-to-tank passageway).

Referring to FIG. 9 showing a section view of the filter element 110, it should be understood that the filter element 110 is generally similar to the filter element 10 with exception to the protrusion 138. The upper plate 124 is rotationally attached to the filter cap 28 with a vertical lock mechanism 80, such as with a snap-feature type connection located generally at the centerline CL, to permit the filter element 10, 110 to rotate relative to the filter cap. An upper surface 82 of the upper plate 124 may engage an interior surface 84 of the filter cap 28 at a radial distance from the centerline CL. An engaging portion 86 of the filter cap 28 has threads 32 and engages the threads 34 of the housing 16, 116 (see FIG. 6 and FIG. 8). It is possible that threads may be disposed on an inward surface 88 of the engaging portion 86 or an outward surface 90 of the engaging portion.

When the filter cap 28 and the filter element 10, 110 are installed into the housing 16, 116, the threads 32 of the filter cap 28 engage the threads 34 on the housing, and the filter cap rotates with respect to the housing as dictated by the configuration of the threads 32, 34 as the filter 30 axially displaces down into the first portion 40 of the housing configured to receive the filter 30. The filter element 10, 110 is independently rotatable from the filter cap 28 about centerline CL, and is rotated with respect to the housing 16, 116 to the predetermined position P1 as the guiding tab 36 (or other orientation structure 12) is guided on the internal element guide path 48, 148 (or other receiving structure 14, 114).

In embodiments of rotational filter assemblies 18, 118 having the filter element 10, 110 with orientation structure 12 that is received in receiving structure 14, 114, upon installation of the filter 30 into the housing 16, 116, the filter element is rotated to a predetermined radial and axial position to cooperate with the vehicle components, such as the regulator valve 44 and the return-to-tank passageway 74.

What is claimed is:

1. A rotational filter assembly for cooperation with a vehicle component comprising:
a generally cylindrical filter defining an axial centerline, the filter having a filter cap and a filter element attached to the filter cap, the filter element being rotational with respect to the filter cap, wherein the filter element further comprises:
a filter media generally centered on the centerline; and
an orientation structure extending radially with respect to the centerline;
a housing having a generally cylindrical inner surface generally centered about the centerline, the inner surface defining a receiving structure configured for receiving and engaging the orientation structure of the filter element;
wherein the filter element is independently rotational of the filter cap with respect to the housing, and the receiving structure of the housing guides the orientation structure such that the filter element has a predetermined rotational position with respect to the housing, irrespective of the rotational position of the filter cap to the housing.

2. The rotational filter assembly of claim 1 wherein the orientation structure is a guiding tab.

3. The rotational filter assembly of claim 1 wherein the receiving structure is an internal element guide path defined by at least one inwardly projecting body forming the inner surface of the housing, wherein a portion of the internal element guide path is an internal element guide passage configured for engaging the orientation structure between opposing walls of the passage.

4. The rotational filter assembly of claim 1 further comprising a protrusion extending from the filter element in the axial direction and parallel to the centerline, the orientation structure being radially aligned with the protrusion with respect to the centerline.

5. The rotational filter assembly of claim 4 wherein the housing one of houses and defines the vehicle component, wherein upon installation of the filter element into the housing, and upon the receiving structure receiving the orientation structure of the filter element, the protrusion is rotationally and axially aligned with the vehicle component.

6. The rotational filter assembly of claim 4 wherein the protrusion comprises multiple protrusions that are equal in number to the number of orientation structures, and wherein the receiving structure comprises multiple internal element guide passages that are equal in number to the number of protrusions.

7. The rotational filter assembly of claim 1 further comprising a bottom plate attached to the filter media opposite from the rotational attachment of the filter element to the filter cap; wherein the protrusion extends from the bottom plate, and wherein the guiding tab extends from the bottom plate.

8. A filter element for attachment to a filter cap, comprising:
a generally cylindrical filter media defining an axial centerline;
an upper plate attached to the filter media and configured to be rotationally attachable to the filter cap such that the upper plate and the filter media are rotational about the centerline with respect to the filter cap;
a bottom plate attached to the filter media opposite from the upper plate; and
an orientation structure extending from the bottom plate radially from the centerline.

9. The filter element of claim 8 wherein the orientation structure is a guiding tab.

10. The filter element of claim 8 further comprising a protrusion extending from the bottom plate in the axial direction and parallel to the centerline, wherein the orientation structure is radially aligned with the protrusion with respect to the centerline.

11. The filter element of claim 10 wherein the protrusion further comprises multiple protrusions that are equal in number to the number of orientation structures.

12. The filter element of claim 10 wherein the protrusion further comprises an O-ring.

13. The filter element of claim 8 wherein the upper plate is rotationally attached to the filter cap with a vertical lock mechanism

14. A method of orienting a filter element with respect to a housing, where the filter element is attached to a filter cap to form a filter, the method comprising the steps of:
engaging the filter cap of the filter with the housing;
guiding an orientation structure of the filter element of the filter in a receiving structure of the housing; and
rotating the filter element independently of the filter cap with respect to the housing, wherein the rotation of the filter element is determined by the engagement of the orientation structure with the receiving structure and the geometry of the receiving structure, wherein the filter element is rotated by the receiving structure to a predetermined rotational position with respect to the housing.

15. The method of claim 14 further comprising the step of rotating the filter cap with respect to the housing.
